(19) United States
(12) Patent Application Publication
(10) Pub. No.: US 2003/0046067 A1
(43) Pub. Date: Mar. 6, 2003

(54) Method for the algebraic codebook search of a speech signal encoder

(76) Inventor: Dietmar Gradl, Tirschenreuth (DE)

Correspondence Address: U.S. Philips Corporation, 580 White Plains Road, Tarrytown, NY, 10591, US

(21) Appl. No.: 10/218,219

(22) Filed: Aug. 13, 2002

(30) Foreign Application Priority Data
Aug. 17, 2001 (DE) 10140507.3

(51) Int. Cl. G10L 19/00

(52) U.S. Cl. 704/217

(57) ABSTRACT

A method for the algebraic codebook search of a speech signal encoder, preferably using the Code Excited Linear Prediction process, in which, in order to calculate coefficients of the triangular matrix of the auto-correlation matrix of the Toeplitz type, a time interval comprising n speech signal samplings is divided into an integral number of tracks t with p possible pulse positions each, and in which the coefficients are stored in a memory grouped in combinations of adjacent tracks, combinations of non-adjacent tracks, combinations of identical tracks, and coefficients of the main diagonals of the auto-correlation matrix.

The invention relates to a method for the algebraic codebook search of a speech signal encoder, preferably using the Code Excited Linear Prediction process, in which, in order to calculate coefficients of the triangular matrix of the auto-correlation matrix of the Toeplitz type, a time interval comprising n speech signals is broken down into an integral number of tracks t with p possible pulse positions each. The invention also relates to a communication device, in particular a mobile telephone with a speech signal encoder.

Such methods are used in digital speech transmission procedures. If an analog speech signal is converted into a digital signal at a particular sampling rate, a very large quantity of data is produced which cannot be fully transmitted via a limited throughput radio channel. For this reason after digitization of the speech signal, the signal is compressed. A signal is compressed in that irrelevant elements are omitted, repeated elements are given an abbreviated name and only these abbreviated names are transmitted as codes. In the field of coding processes for mobile phone uses, the CELP (Code Excited Linear Prediction) method has achieved particular importance. In this efficient coding method, sound elements stored in an auto-correlation matrix are identified and transferred as coefficients. The auto-correlation matrix can be compared with a notebook or codebook of which only the notebook address is transferred. The receiver necessarily requires the same notebook in order to convert the received digital signal into an analog speech signal as close as possible to the original signal.

A number of encoders/decoders are standardized internationally by the ITU, including the methods CS-ACELP and ACELP which work with bit rates of up to 8 kbps.

In this CELP process first an LPC analysis (linear prediction coefficient) is made. The remaining signal is then quantified by a search process in an adaptive codebook. In this way periodic parts of the speech signal are filtered out in LTP analysis (long term prediction). The remaining signal is quantified in a second book; there are already a number of solutions for this process. In the AMR process (adaptive multirate speech codec) an algebraic codebook is used. The principle of the algebraic codebook search is based on searching for a code vector which represents a particular time interval and in which a limited number of pulses have an amplitude of +1 or −1. This code vector is filtered through a synthesis filter, i.e. the decoding process is performed on the sender side which, after transmission of the signal, is performed on the receiving side. A very large number of possible code vectors is systematically checked by nested search loops in order to determine the code vector which has the least error energy i.e. which is as similar as possible to the original signal. This iterative determination of the code vector takes up the major part of the computing capacity of a mobile phone so that optimization of this search algorithm is particularly efficient. Firstly it is desirable to reduce the number of memory places required as the RAM elements required for this are relatively expensive, secondly the aim is to reduce the required number of computing operations of the search algorithm.

The auto-correlation matrix is a Toeplitz matrix i.e. it is symmetrical in relation to its main diagonals and its upper triangular matrix and/or its identical lower matrix contains all coefficients. It has therefore already been proposed, instead of the complete auto-correlation matrix, to store only one of the triangular matrices to save memory space. This process however leads to a complicated addressing of the individual coefficients so that the saving in memory space is offset by an increase in computing complexity.

The invention therefore has for its object to provide a method in which the required memory space and the computing complexity are reduced.

To solve this problem in a method of the type mentioned initially it is proposed according to the invention that the coefficients are stored in a memory grouped in combinations of adjacent tracks, combinations of non-adjacent tracks, combinations of identical tracks, and coefficients of the main diagonals of the auto-correlation matrix.

In the method according to the invention, the required coefficients of the auto-correlation matrix are stored in a manner which allows rapid sequential access. The relatively complex calculation of memory addresses for the coefficients of the triangular matrix, which would otherwise be required, can be considerably simplified. Some coefficients are required very often and others only very rarely. This circumstance is utilized in the optimized grouping so that the frequently required coefficients of the auto-correlation matrix can be addressed more simply, which results in very rapid access.

The invention proposes that for the groups of combinations of adjacent and non-adjacent tracks in each case t data records of p×p coefficients each are stored. An operating mode of the CELP or ACELP process, very important in practice, provides that the positions of two adjacent pulses are established simultaneously so that for p possible pulse positions per code vector, there are p×p passages through the search loop.

An extremely rapid and simple access to the coefficients required in the search loop can be achieved if the coefficients are stored sequentially in a memory.

In a further embodiment of the invention it is provided that a sub-group of a data record with p coefficients representing a horizontal or vertical vector of the auto-correlation matrix is read through a program loop where a value indicating the memory point of the first coefficient and a constant step width to the next memory point are prespecified. Accordingly it is sufficient to define a starting or initial value for the first memory address and the step width i.e. the number of memory places to the next memory point in each case. It can be provided that the start values of a lookup table stored in the hard memory are used, alternatively they are calculated.

The step width one is advantageously selected for the data records of the group of combinations of adjacent tracks. The coefficients are stored sequentially and can be read particularly simply.

For the data records of the group of combinations of non-adjacent tracks it is recommended to select step width p.

To reduce the memory space required for the group of combinations of identical tracks t triangular matrices can be stored sequentially. One triangular matrix corresponds to each combination of identical tracks and every t triangular matrices are stored in a block. As these coefficients are required relatively rarely, it is no disadvantage if access is slightly more complex. To reduce the computing complexity further, access can again be made via a lookup table.

The coefficients of the main diagonals are combined in a group and stored sequentially.

It has proved favorable if within a time interval 40 speech signal samplings are performed. If this value is selected the process is compatible with internationally established rules. For a typical sampling rate of 8 kHz for the speech signal a time interval of 20 msec is required, within this short time interval the speech signal can be regarded as quasistationary and be represented by a code vector.

The auto-correlation matrix is preferably a 40×40 matrix corresponding to the 40 speech signal samplings in a time window.

To reduce the number of iterations in the process according to the invention it is provided that a time interval is broken down into an integral number of tracks of equal length. Preferably a time interval is broken down into 5 tracks of 8 pulse positions each or 4 tracks of 10 pulse positions each.

Particularly rapid access to the coefficients is achieved if the coefficient groups of combinations of adjacent and non-adjacent tracks are formed from a majority of blocks comprising 64 coefficients each. During the iteration these coefficient groups must be accessed particularly often. These groups are therefore stored in the order in which they are required for calculation so they can be accessed quickly; this leads to a reduction in computing complexity.

Particularly good results can be achieved if 320 values are determined for the coefficient group of the combination of adjacent tracks. For the coefficient group of combinations of non-adjacent tracks suitably also 320 values are determined. The coefficient group of combinations of identical tracks contains 140 values; together with the coefficients of the main diagonals a total of 820 coefficients are determined.

A further increase in computing speed can be achieved if the memory has several RAM memory banks and the coefficient groups are stored in different RAM memory banks. If the coefficient groups are stored in different RAM memory banks they can be accessed in parallel, i.e. two coefficients can be read simultaneously. The memory access time can thus be approximately halved.

The method according to the invention can be particularly advantageously integrated into the operating system of a mobile phone.

The invention will be further described with reference to examples of embodiments shown in the drawings to which however the invention is not restricted. The figures are diagrammatic and show:

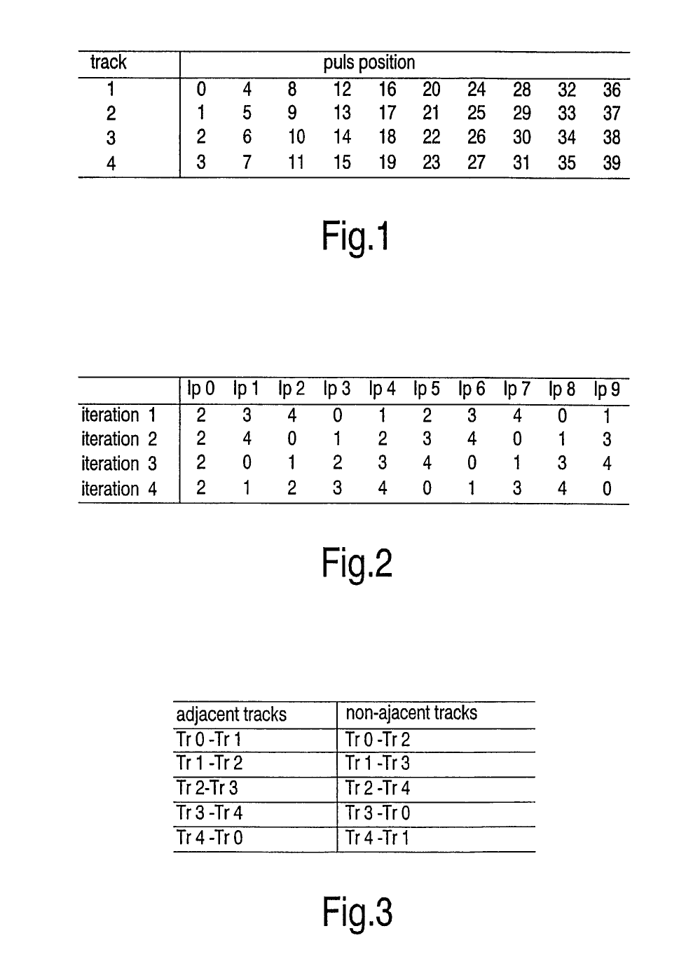

FIG. 1 the breakdown of a time interval into 4 tracks with 10 possible pulse positions each;

FIG. 2 a table of the track/pulse combinations to be tested;

FIG. 3 a table of the adjacent and non-adjacent tracks;

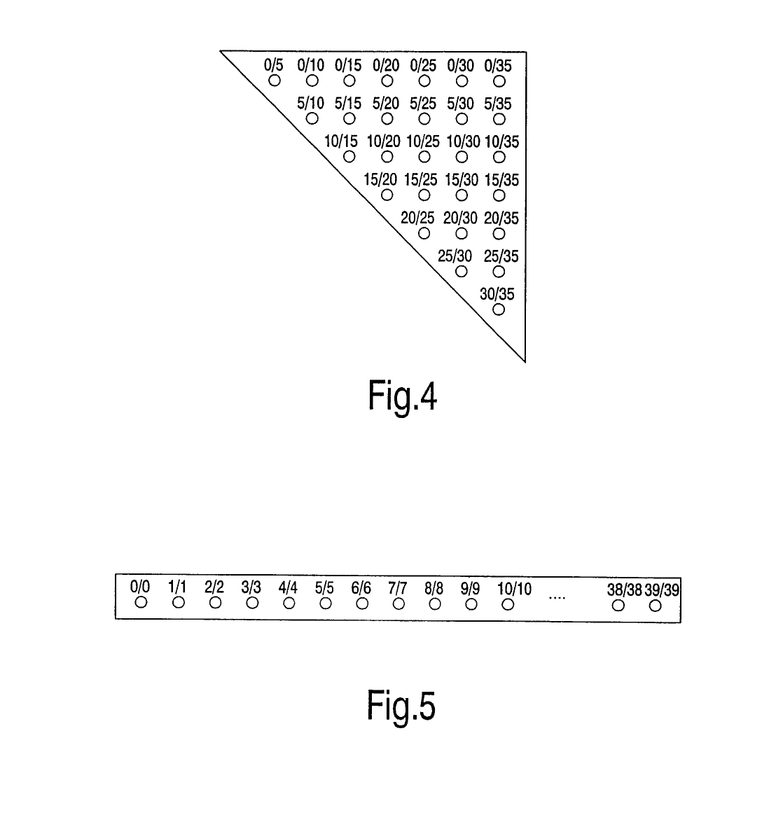

FIG. 4 a triangular matrix with coefficients of a combination of identical tracks;

FIG. 5 the coefficients of the main diagonals;

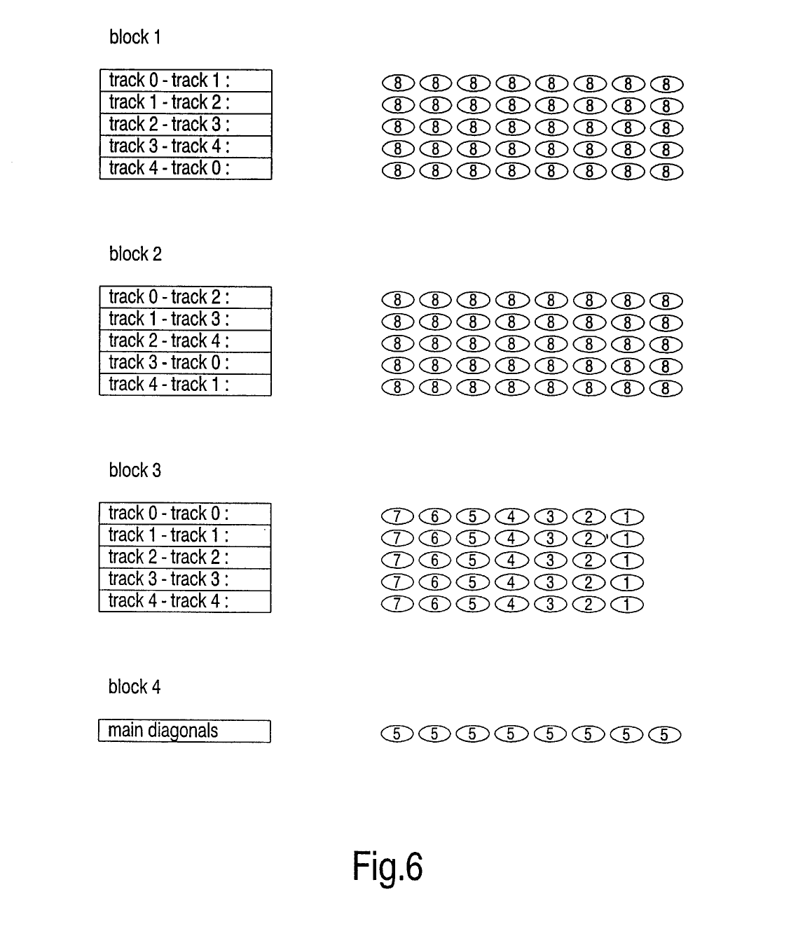

FIG. 6 an overview of all coefficients to be calculated;

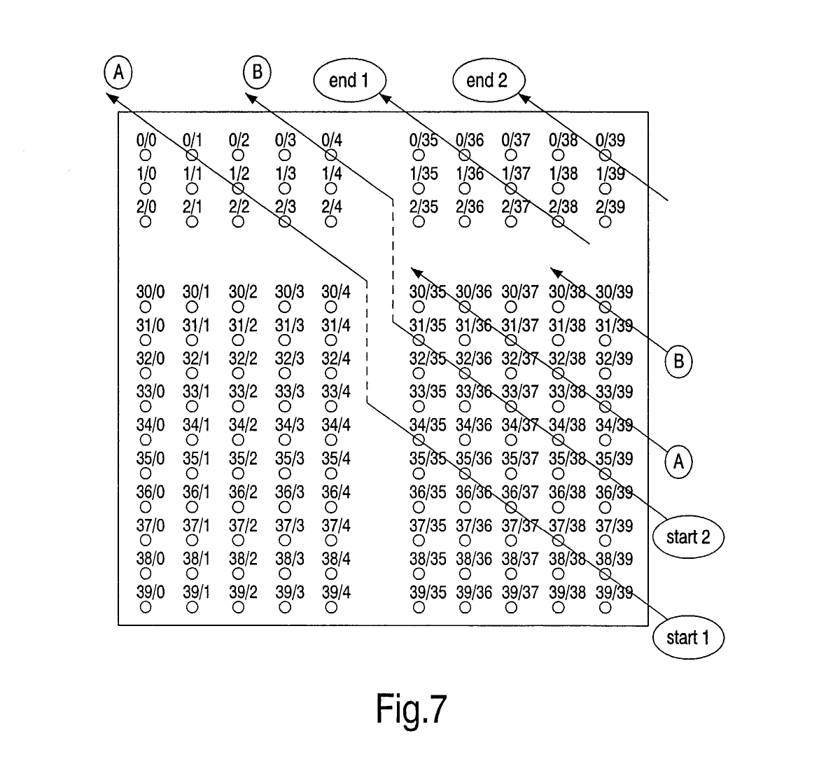

FIG. 7 the calculation of the group of combinations of adjacent tracks (block 1);

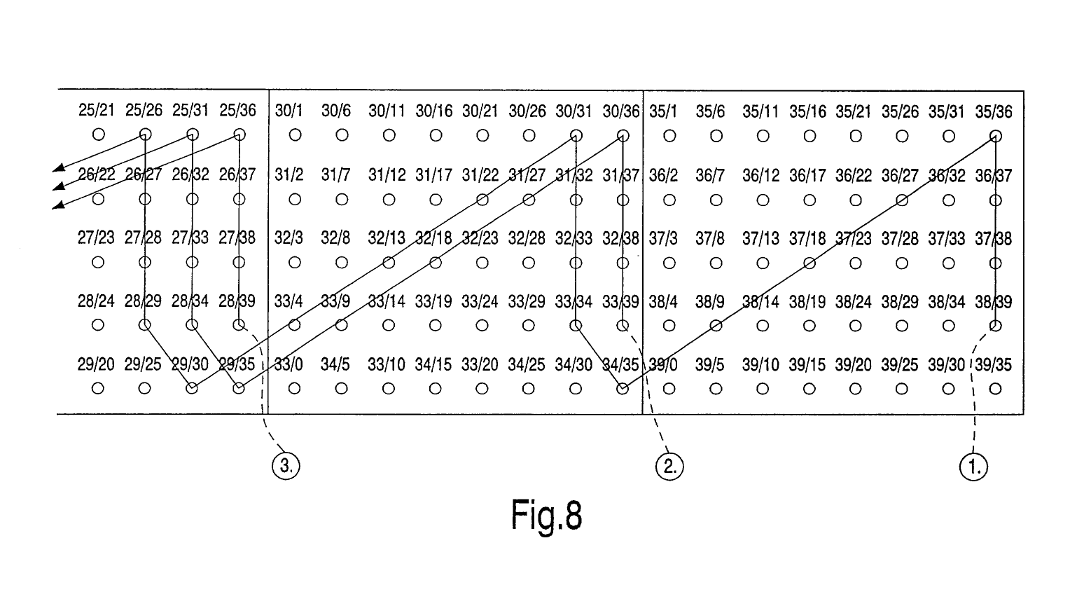

FIG. 8 the memory sequence of block 1 after the first step;

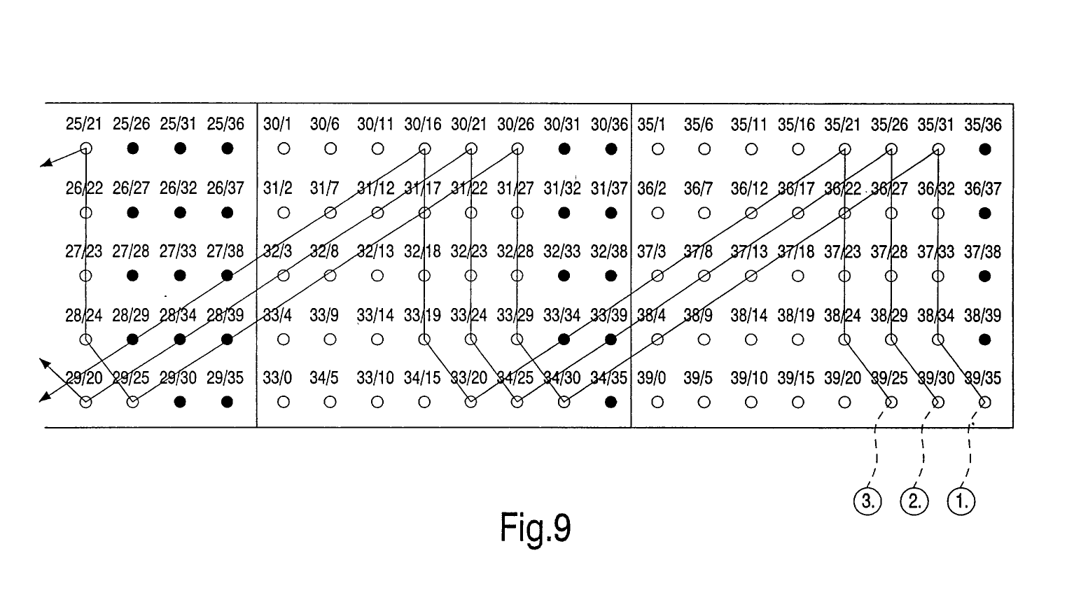

FIG. 9 the memory sequence of block 1 after the second step;

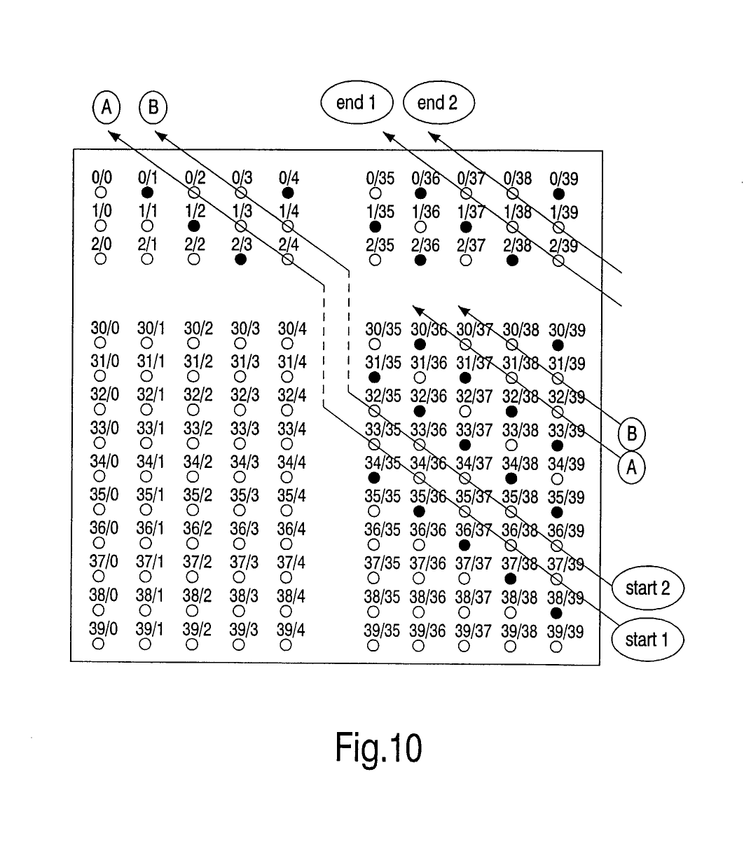

FIG. 10 the calculation of the group of combinations of non-adjacent tracks (block 2);

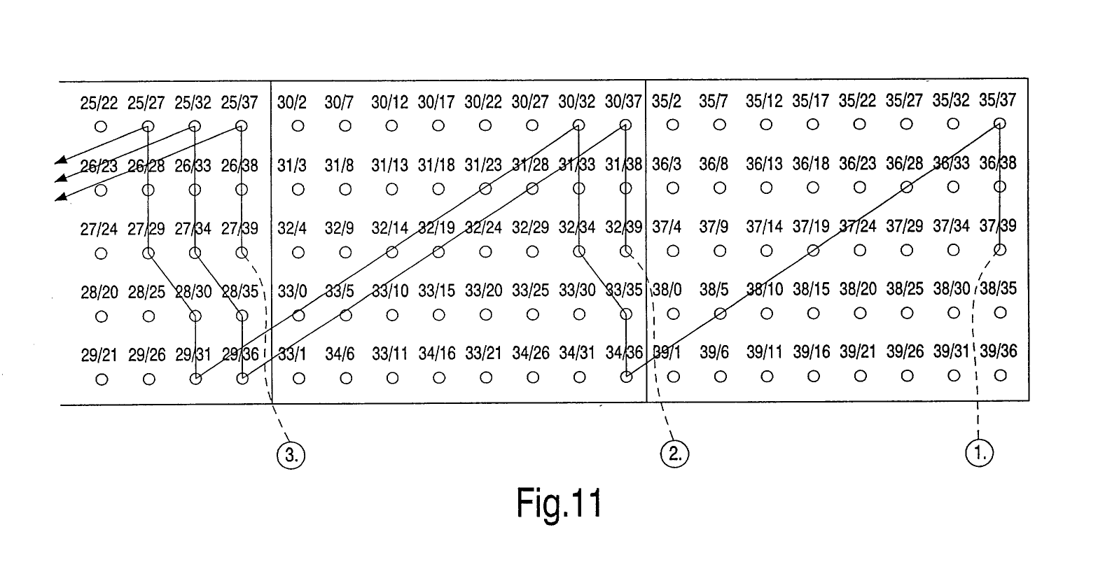

FIG. 11 the memory sequence of block 2 after the first step;

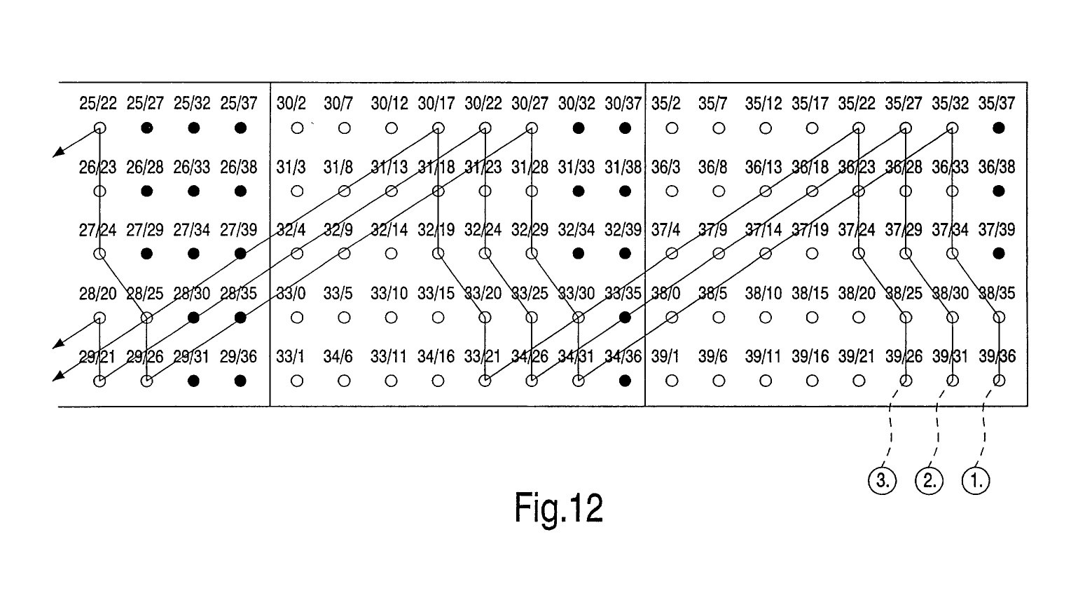

FIG. 12 the memory sequence of block 2 after the second step;

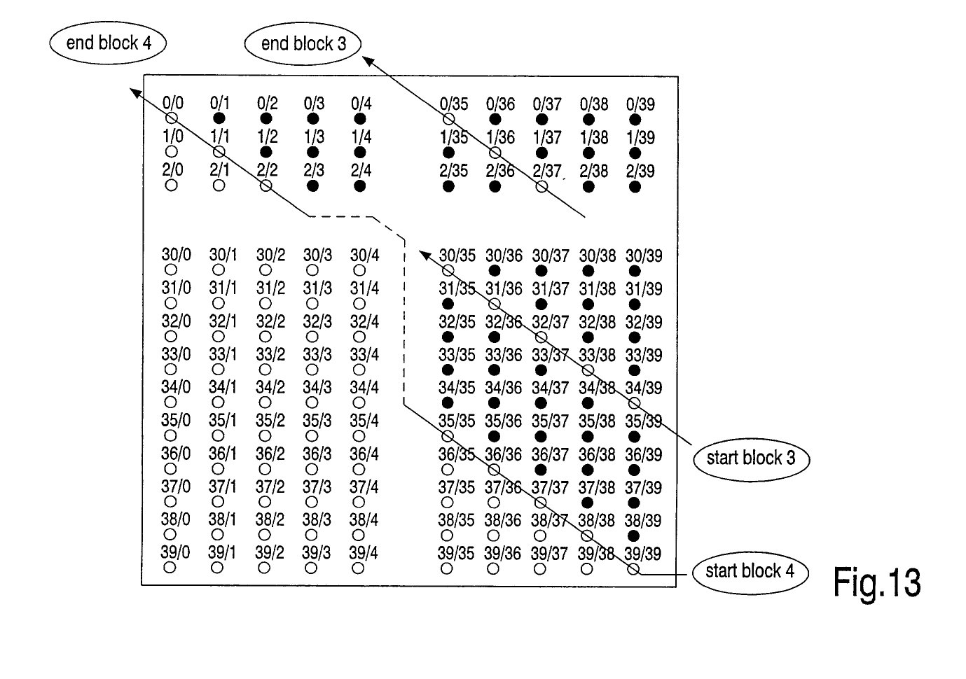

FIG. 13 the calculation of the block with the values of identical tracks (block 3); and

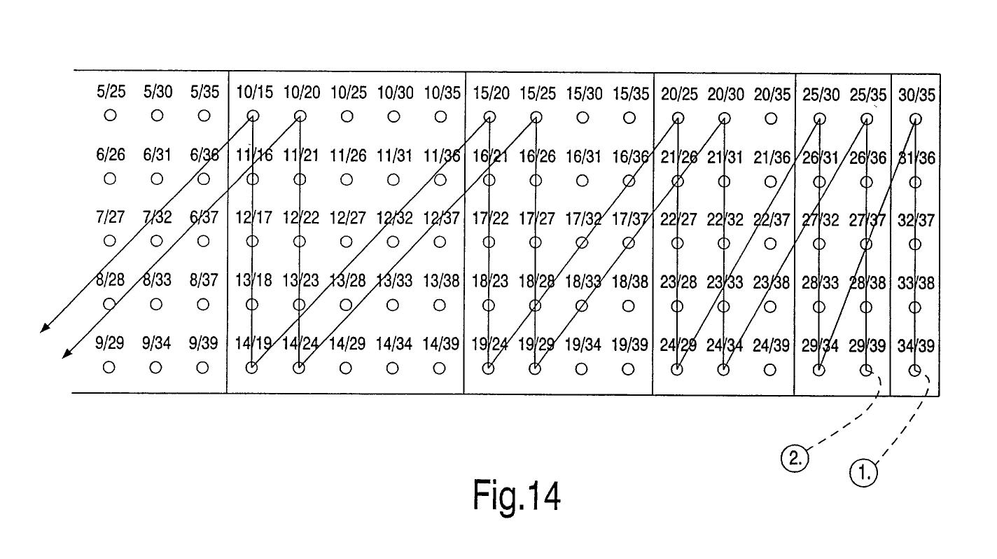

FIG. 14 the memory space sequence of block 3.

By an iterative search process the code vectors are determined which correspond best to the actual signal i.e. those of which the error energy is minimal. Within the search process the pulses are determined in succession so that the number of variables is reduced as the search progresses.

The table in FIG. 1 shows the breakdown of a time interval comprising 40 speech signal samplings into four tracks each of ten pulse positions. Another breakdown which in practice is important is a breakdown into five tracks of eight possible pulse positions each. For each pulse it is defined in which track it can be placed. The first pulse can therefore only be placed at 10 (or 8) positions instead of all 40 positions. Iteratively the pulse position is selected which has the lowest error energy. Then the next pulse position is determined iteratively, taking into account the first pulse position already established. This process is performed for all pulses.

For certain frequently occurring operating modes, two adjacent pulses are determined at the same time. For this all combinations of two pulses are calculated and the best pulse pair is determined taking into account the pulse pairs already set. In an operating mode in which a track has eight pulse positions, 8×8=64 calculations are required; in the case of a track with 10 pulse positions 10×10=100 calculations must be performed for each pulse pair. The example below relates to the process in which a pulse pair is determined simultaneously.

FIG. 2 shows a table of the track/pulse combinations to be tested for the operating mode in which eight pulses are set. The first pulse Ip0 is set in the track containing the maximum of the back-filtered target signal. This definition is made before the actual search loop and applies to the entire search loop. In the embodiment shown the maximum of the back-filtered target signal is in track 2. Therefore this value is maintained for pulse Ip0 in all iterations. The second pulse Ip1 is determined in that all 8 possible pulse positions of a track are determined. As can be seen from FIG. 2, in iteration 1 the 8 positions of track 3 are tested. The pulse positions of track 3 with the least error energy are selected. After definition of Ip0 and Ip1, the 64 possible combinations for pulses Ip2 and Ip3 are tested. As can be seen from FIG. 2, Ip2 must for the first iteration be found in track 3 and Ip4 in track 0. Then the pulse pairs Ip4-Ip5, Ip6-Ip7 and Ip8-Ip9 are defined in the same process. When all combinations have been tested, the code vector with minimal error energy is stored and iteration 2 is performed in the same way. The pulse with the least error energy is selected. The code vector of this iteration is most similar to the target vector. For each iteration four pulse pairs must be checked i.e. a total of 4×64=256 calculations. For 4 iterations therefore 1024 calculations must be performed.

FIG. 3 shows a table of the adjacent and non-adjacent tracks which are checked together. From FIG. 2 it is clear that certain combinations of tracks occur frequently e.g. Tr0-Tr1, Tr1-Tr3, whereas others do not occur at all. Of all conceivable code vectors only a small selection are checked. The left column of FIG. 3 contains the adjacent tracks necessary for the search process. The search process is divided into the actual search loop in which access is made to a block of 64 values of the auto-correlation matrix; for four iterations with four pulse pairs each with 64 values each, a total of 1024 matrix accesses are then made.

Outside the search loop access is made to eight values, in total 1280 accesses are made to the auto-correlation matrix. In conventional processes the total auto-correlation matrix is stored with 40×40=1600 values. As however in each case blocks of 64 values are required, they are stored together. The sequence within the block is selected so that the values can be accessed through a program loop of constant step width without the complex calculation of memory addresses being required.

As can be seen from the left-hand column of FIG. 3, there are five groups each of 64 values of adjacent tracks with a total of 320 values. Thus there are also five combinations of non-adjacent tracks each comprising 64 values, so that here again a total of 320 values must be calculated.

FIG. 4 shows a diagonal matrix with the coefficients of a combination of two identical tracks for example Tr0-Tr0. This triangular matrix contains 28 coefficients. From the five combinations of identical tracks, a block of a total of 140 values is formed. Access to this block is relatively rare as only 10% of all accesses fall into this category. For this reason it is no disadvantage if access i.e. addressing of the coefficient is slightly more complex. It is also possible to use an allocation table for access.

FIG. 5 shows the coefficients of the main diagonals. As in total 40 signal samplings are made in a time interval, the main diagonal contains 40 elements which are stored sequentially in a block.

In total 320 coefficients of the combinations of adjacent tracks, 320 coefficients of the combinations of non-adjacent tracks, 140 coefficients of the combinations of identical tracks and 40 coefficients of the main diagonals must be calculated, so 820 coefficients in total.

FIG. 6 shows all coefficients to be calculated in groups. Each ellipsoid symbol indicates a sub-group with a particular number of coefficients. In blocks 1 and 2 each sub-group has eight coefficients, in block 4 five coefficients. The number of coefficients in block 3 differs because of the diagonal matrix.

The calculation of the individual blocks will now be explained in more detail. Each of the blocks 1 to 4 can be calculated separately. Blocks 1 and 2 are generated in practically an identical manner in two steps. In FIG. 7 these steps are shown for block 1. The first step begins at values (38/39) of the auto-correlation matrix. The matrix is run diagonally until the diagonal drawn in FIG. 7 reaches the value 0/1. The end value is marked ‘A’ and continues on the right-hand side at the value (33/39) marked ‘A’. The same applies to symbol ‘B’.

The memory sequence of block 1 after the first step is shown in FIG. 8, the arrows indicate in which order the coefficients from the auto-correlation matrix are stored in the block comprising 8×8 values. The second sub-step begins at value (35/39) as shown in FIG. 7. This diagonal runs to value (0/4) and the second part begins at value (30/39) and so on.

FIG. 9 shows the memory sequence of block 1 after the second sub-step. All values which were already stored in the first step are marked in FIG. 9 with black dots. Through this second step the entire block is filled. The first line contains the correlation values of Track0-Track1, the second line the correlation values of Track1-Track2 etc. according to FIG. 7.

FIG. 10 shows the calculation of block 2 with the values of non-adjacent tracks which can be generated in the same way. In the same way as block 1 in FIG. 10 the diagonals required are drawn. The first part begins at value (37/39). This diagonal runs to value (0/2), the first part is continued at value (32/39).

FIG. 11 shows the memory sequence of block 2 after this first step. The second part begins at the value (36/39). The diagonal continues to value (0/3), the second part continues at value (31/39).

FIG. 12 shows the memory sequence of block 2 after the second step. All values already stored in the first step are marked with dots.

FIG. 13 shows the calculation of the blocks of combinations of identical tracks. In the same way as the previous examples the diagonals required are drawn. Block 3 can be calculated with a single passage. The memory sequence of block 3 is shown in FIG. 14.

The coefficients for block 4 are the values of the main diagonals of the auto-correlation matrix.

In comparison with the conventional solution in which 1600 coefficients are calculated and stored, in this process only 820 coefficients must be calculated. This gives a reduction in computing complexity of approximately 30%. The RAM memory requirement is reduced by around 40%.

To shorten the computing time further, blocks 1 and 2 are stored in separate RAM memory banks of a memory so that the two values can be read simultaneously.

1. A method for the algebraic codebook search of a speech signal encoder, preferably using the Code Excited Linear Prediction process, in which, in order to calculate coefficients of the triangular matrix of the auto-correlation matrix of the Toeplitz type, a time interval comprising n speech signal samplings is broken down into an integral number of tracks t with p possible pulse positions each, characterized in that the coefficients are stored in a memory grouped in
combinations of adjacent tracks;
combinations of non-adjacent tracks;
combinations of identical tracks; and
coefficients of main diagonals of the auto-correlation matrix.

2. A method as claimed in claim 1, characterized in that for the groups of combinations of adjacent and non-adjacent tracks in each case t data records with p×p coefficients each are stored.

3. A method as claimed in claim 1 or 2, characterized in that the coefficients are stored sequentially in a memory.

4. A method as claimed in claims 2 or 3, characterized in that a sub-group of a data set with p coefficients, representing a horizontal or vertical vector of the auto-correlation matrix, is read through a program loop where a value indicating the memory point of the first coefficient and a constant step width to the next memory point are prespecified.

5. A method as claimed in claim 4, characterized in that for the data records of the group of combinations of adjacent tracks the step value 1 is selected.

6. A method as claimed in claim 4, characterized in that for the data records of the group of combinations of non-adjacent tracks the step value p is selected.

7. A method as claimed in any of the previous claims, characterized in that for the group of combinations of identical tracks t triangular matrices are stored sequentially.

8. A method as claimed in claim 7, characterized in that access to the coefficients of the group of identical tracks takes place via a lookup table.

9. A method as claimed in any of the previous claims, characterized in that the coefficients of the main diagonals are stored sequentially.

10. A method as claimed in any of the previous claims, characterized in that 40 speech signal samplings are contained within a time interval.

11. A method as claimed in any of the previous claims, characterized in that the auto-correlation matrix is a 40×40 matrix.

12. A method as claimed in any of the previous claims, characterized in that a time interval is divided into five tracks of eight possible pulse positions each.

13. A method as claimed in any of claims 1 to 11, characterized in that a time interval is divided into four tracks of ten possible pulse positions each.

14. A method as claimed in any of the previous claims, characterized in that for the group of combinations of adjacent tracks 320 coefficients are determined.

15. A method as claimed in any of the previous claims, characterized in that for the group of combinations of non-adjacent tracks 320 coefficients are determined.

16. A method as claimed in any of the previous claims, characterized in that for the group of combinations of identical tracks 140 coefficients are determined.

17. A method as claimed in any of the previous claims, characterized in that a total of 820 coefficients are determined.

18. A method as claimed in any of the previous claims, characterized in that coefficient groups are stored in various RAM memory banks of a memory having several RAM memory banks.

19. A communication device with a speech signal encoder, in particular a mobile phone, characterized in that it includes an operating system with a method as claimed in any of the claims 1 to 18.
